(19) United States
(12) Patent Application Publication
(10) Pub. No.: US 2007/0084127 A1
(43) Pub. Date: Apr. 19, 2007

(54) Weather strip for automobile and method for fabricating same

(76) Inventors: Naoki Muraoka, Hiroshima-ken (JP); Masahiro Okamine, Hiroshima-ken (JP)

Correspondence Address: FLYNN THIEL BOUTELL & TANIS, P.C., 2026 RAMBLING ROAD, KALAMAZOO, MI, 49008-1631, US

(21) Appl. No.: 11/493,219

(22) Filed: Jul. 26, 2006

(30) Foreign Application Priority Data
Oct. 19, 2005 (JP) 2005-304464

(51) Int. Cl. E06B 7/16

(52) U.S. Cl. 49/490.1

(57) ABSTRACT

There is provided an automobile weather strip light in weight and excellent in appearance of the surface thereof, and also having sufficient hardness and strength. The automobile weather strip comprises a fitting base and a bulb shape, wherein the fitting base is formed of a dense rubber material with porosity containing air bubbles not more than 100 μm in average diameter, obtained by mixing a predetermined amount of thermal expansion microcapsules each having particles 3 to 20 μm (preferably, 5 to 15 μm) in average diameter, an expansion start temperature in a range of 110 to 150° C., a maximum expansion temperature in a range of 130 to 150° C., and a shell-wall made of acrylonitride copolymer to be subsequently foamed in a vulcanization process.

### FIELD OF THE INVENTION

The invention relates to an automobile weather strip light in weight and excellent in appearance of the surface thereof, having sufficient hardness and strength, and a method for fabricating the same.

### BACKGROUND OF THE INVENTION

Further reduction in weight has lately been required for an automobile weather strip from the viewpoint of lower fuel consumption, as with other components of the automobile. And although a fitting base of the weather strip has been formed of a dense rubber in the past, there is now a tendency to form the fitting base by use of a dense rubber material with porosity in an attempt to achieve further reduction in weight.

When the fitting base was formed of a dense rubber in the past, a chemical blowing agent was mixed into the dense rubber, and the dense rubber was foamed due to the effect of the chemical blowing agent being foamed by the heat generated in a vulcanization process, thereby having turned the dense rubber into the dense rubber material with porosity.

### SUMMARY OF THE INVENTION

A dense rubber material with porosity formed by use of a chemical blowing agent has a specific gravity of around 1.10, and further reduction in its weight is required.

However, if the dense rubber material with porosity is caused to undergo expansion by use of the chemical blowing agent to a specific gravity of 1.10 or less, this will cause visible roughness to appear at paces on the surface of the dense rubber material with porosity because air bubbles are on the order of 500 μm in average diameter, thereby creating a problem of not only occurrence of poor surface appearance but also deterioration in strength.

Furthermore, when a metal core member 13 is embedded in a fitting base 11 of a weather strip, so-called blisters occur at an interface therebetween, and holding strength of the weather strip, against a flange, decreases, so that falling-off of a product and/or defects due to water leakage are prone to occur. In addition, poor surface appearance of the product also results due to presence of the blisters. This phenomenon is often observed particularly when the weather strip is fabricated by a fluidized-bed vulcanization process (HFB line).

In view of those problems described as above, the invention had been developed, and it is an object of the invention to provide an automobile weather strip light in weight and excellent in appearance of the surface thereof, having sufficient strength.

Referring to FIGS. 1 and 2, the invention is summed up hereinafter. In accordance with one aspect of the invention, there is provided an automobile weather strip comprising a fitting base 11 and a bulb shape 12, wherein the fitting base 11 is formed of a dense rubber material with porosity containing air bubbles not more than 100 μm in average diameter, obtained by mixing a predetermined amount of thermal expansion microcapsules each having particles 3 to 20 μm (preferably, 5 to 15 μm) in average diameter, an expansion start temperature in a range of 110 to 150° C, a maximum expansion temperature in a range of 130 to 150° C., and a shell-wall made of acrylonitride copolymer to be subsequently foamed in a vulcanization process.

In accordance with another aspect of the invention, there is provided a method for fabricating an automobile weather strip comprising a fitting base 11 and a bulb shape 12, said method including the step of forming the fitting base 11, comprising the steps of preparing a predetermined amount of thermal expansion microcapsules each having particles 3 to 20 μm (preferably, 5 to 15 μm) in average diameter, an expansion start temperature in a range of 110 to 150° C., a maximum expansion temperature in a range of 130 to 150° C., and a shell-wall made of acrylonitride copolymer, mixing the predetermined amount of the thermal expansion microcapsules to be subsequently foamed in a vulcanization process, wherein the shell-walls are caused to expand with rubber still in soft state before the rubber is vulcanized and the shell-walls having a low melting point (not higher than about 150° C.) are in use, thereby causing the shell-walls to be melt in a rubber vulcanizing furnace, and forming a dense rubber material with porosity with a smoothed surface, containing air bubbles not more than 100 μm in average diameter, using the thermal expansion microcapsules small in average particle diameter, and expansion multiplying factor.

Since the fitting base 11 of the automobile weather strip according to the invention is formed of the dense rubber material with porosity containing the air bubbles not more than 100 μμm in average diameter, obtained by mixing the predetermined amount of the thermal expansion microcapsules as prescribed, it is possible to achieve reduction in weight of the fitting base 11, and the weather strip 10 as a whole.

Further, because the air bubbles formed in the fitting base 11 are extremely small in diameter, 100 μm or less on average, such roughness as visible on the surface thereof are not formed. Accordingly, the surface thereof is as smooth as that of a normal dense rubber, and is excellent in appearance. Furthermore, since the air bubbles are extremely small in diameter, the fitting base 11 exhibits high hardness and strength as compared with one having air bubbles formed by use of a chemical blowing agent.

The method for fabricating the automobile weather strip, according to the invention, is capable of providing the automobile weather strip that is light in weight, and is excellent in appearance, hardness, and strength.

### BRIEF DESCRIPTION OF THE DRAWINGS

FIG. 1 is a side view showing an automobile to which an embodiment of an automobile weather strip according to the invention, is fitted; and

FIG. 2 is a sectional view taken on line X-X of FIG. 1, showing the automobile weather strip according to the embodiment of the invention.

### PREFERRED EMBODIMENTS OF THE INVENTION

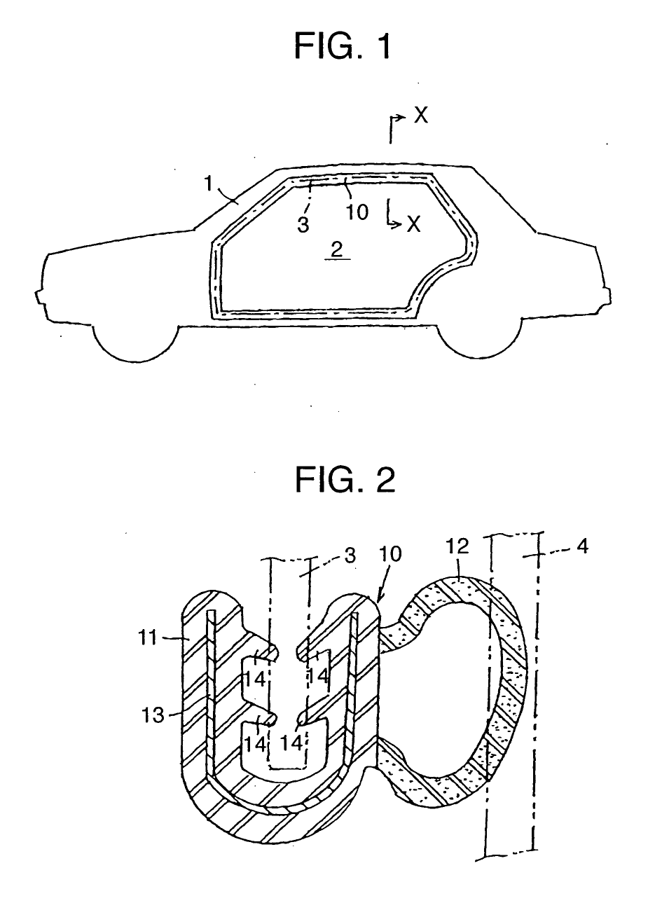

An embodiment of an automobile weather strip 10 according to the invention is described hereinafter with reference to FIGS. 1 and 2.

The weather strip 10 according to the present embodiment comprises a fitting base 11 substantially resembling the letter U in section, with a metal core member 13 embedded therein, and a bulb shape 12 made of a sponge rubber. The fitting base 11 is fitted to a flange 3 formed along a door opening 2 of an automobile body 1, and the bulb shape 12 is brought resiliently in contact with a door panel 4 to thereby seals between the automobile body 1, and the door panel 4. Further, a plurality of retainer lips 14 for clamping the flange 3 are provided on the inner surface of the fitting base 11.

The fitting base 11 is formed of a dense rubber material with porosity (EPDM) containing numerous air bubbles not more than 100 μm in average diameter, obtained by mixing a predetermined amount of thermal expansion microcapsules having particles 3 to 20 μm (preferably, 5 to 15 μm) in average diameter, an expansion start temperature in a range of 110 to 150° C., a maximum expansion temperature in a range of 130 to 150° C., and a shell-wall made of acrylonitride copolymer to be subsequently foamed in a vulcanization process. In this case, an adequate amount of a vulcanization accelerator, together with the thermal expansion microcapsules, is mixed.

The thermal expansion microcapsules are pre-prepared into a master batch for prevention of fly in all directions and enhancement of dispersion to be subsequently mixed by open mills (mixing rolls). The thermal expansion microcapsules can be mixed in a closed mixing machine (a kneader, Banburry mixer, and so forth) on condition that mixing is carried out at an adequate temperature (a temperature at which the thermal expansion microcapsules undergo no expansion). Use of the closed mixing machine eliminates the needs for pre-preparation into the master batch. Further, for the thermal expansion microcapsules, use is made of “Matsumoto Microsphere F—46K” developed by researches conducted in collaboration with Matsumoto Yushi-Seiyaku Co., Ltd.

With the automobile weather strip 10 according to the present embodiment, since the fitting base 11 thereof is formed of the dense rubber material with porosity containing the air bubbles not more than 100 μm in average diameter, obtained by mixing the predetermined amount of the thermal expansion microcapsules, it is possible to achieve reduction in weight of the fitting base 11, and the weather strip 10 as a whole.

Further, because the air bubbles formed in the fitting base 11 are extremely small in diameter, 100 μm or less on average, such roughness as visible on the surface thereof are not formed. Accordingly, the surface thereof is as smooth as that of a normal dense rubber, and is excellent in appearance. Furthermore, since the air bubbles are extremely small in diameter, the fitting base 11 can maintain sufficient hardness and strength.

The thermal expansion microcapsule has physical properties, which can be enumerated as follows.
(A) If the average particle diameter of the thermal expansion microcapsule is less than 3 μm: an addition amount of the thermal expansion microcapsules, necessary to obtain a target specific gravity, will increase, resulting in an increase in compounding cost (1); if the average particle diameter is small, and the air bubbles after expansion of the dense rubber material with porosity have the same diameter (100 μm or less on average), this will cause an expansion multiplying factor to increase, and a shell-wall thickness of each of the capsules tends to decrease, so that there will be a much possibility of an encapsulated gas being released due to rupture of the shell-wall, thereby causing disadvantages in terms of stability in specific gravity, and improvement on a blister problem (2).
(B) Then, if the average particle diameter exceeds 20 μm: in the case of the same expansion multiplying factor, there will occur an increase in the average diameter of each of the air bubbles after expansion of the dense rubber material with porosity, resulting in deterioration of vulcanization property (1); results of tests were obtained that upon evaluation of a thermal expansion microcapsule available in the commercial market, a grade of the thermal expansion microcapsule exceeding 20 μm in average particle diameter, after vulcanization, had an unsmooth surface (2); in reviewing the test described, it is considered that the expansion multiplying factor of the thermal expansion microcapsule, that is, 5 to 7-fold increase (increase in height), is preferable from the viewpoint of stability in expansion, and if the average particle diameter of the thermal expansion microcapsule exceeds 20 μm, the average diameter of the air bubble after the expansion comes to exceed 100 μm (recognizable by visual inspection), thereby leading to degradation in a surface skin after vulcanization (3).
(C) if the expansion start temperature of the thermal expansion microcapsule is below 110° C., the thermal expansion microcapsule starts thermal expansion during mixing operation in a rolling process and the thermal expansion microcapsule will be easily broken in a gap between the rolls and upon shearing, so that not only a desired expansion ratio cannot be obtained but also there occurs variation in specific gravity of a vulcanized product.
(D) then if the expansion start temperature exceeds 150° C.: as the vulcanization of rubber has already started, the thermal expansion microcapsule as added is unable to undergo full expansion, resulting in an increase in specific gravity (1); further, because competition comes to occur between vulcanization and expansion, there exist apprehensions that variation can occur to specific gravity of a product after the vulcanization (2); it is a known fact that the thermal expansion microcapsules exist in a rubber skin layer after the vulcanization, and destruction of a vulcanized rubber can occur due to expansion after the vulcanization, so that degradation of the surface skin is unavoidable (3).
(E) if the maximum expansion temperature of the thermal expansion microcapsule is below 130° C.; the expansion start temperature is naturally below that temperature, so that there is a possibility of occurrence of problem described under (C) as above (1); upon the thermal expansion microcapsule reaching the maximum expansion temperature, slight contraction will start, however, since the vulcanization of the rubber is insufficient if the maximum expansion temperature is below 130° C., there is a possibility of occurrence of a decrease and variation in the specific gravity (2).
(F) if the maximum expansion temperature exceeds 150° C.: since an increase in a melting point is also anticipated, the surface of a product after the vulcanization becomes unsmooth as with the case of using thermal expansion microcapsules of a high-temperature expansion type; further, there can occur variation in the specific gravity and degradation of the surface skin as described under (D) as above (2).
(G) if the average diameter of each of the air bubbles exceeds 100 μm: as the average diameter of each of the air bubbles increases, so occurs deterioration in the physical properties after the vulcanization (1); and an excessive increase in the average diameter will also cause degradation in the surface skin after the vulcanization.

It is deemed that the reasons why the surface of the fitting base 11 is rendered smooth by use of “Matsumoto Microsphere F—46K” for the thermal expansion microcapsules are given as follows: because an expansion temperature is low, the microcapsules undergo expansion before the vulcanization of rubber (while the rubber is still in soft state) (1); since use is made of the microcapsule with a shell-wall (shell) having a low melting point, the shell-wall is melt at a rubber- vulcanization temperature, thereby exhibiting an effect of smoothing out the surface (2): and the microcapsules are small in average particle diameter, and expansion multiplying factor (3).

Incidentally, if the thermal expansion microcapsules of the high-temperature expansion type is used, the thermal expansion microcapsules start expansion at a point in time when some progress has been made in vulcanization of rubber to thereby destroy a rubber skin layer, whereupon the thermal expansion microcapsules are melt with little smoothing effect, so that roughness are left out on the surface of a product, and a surface texture of excellent appearance cannot be obtained.

The thermal expansion microcapsules of the high-temperature expansion type adopts a shell-wall having a high melting point in comparison with that for the thermal expansion microcapsules of a low-temperature expansion type, and an encapsulated gas having a high boiling point.

Since the thermal expansion microcapsules according to the embodiment of the present invention do not cause a gas to be evolved unlike the chemical blowing agent, blisters hardly occur at an interface between the metal core member 13 and the fitting base 11 of the weather strip. Accordingly, a sufficient holding strength of the fitting base 11, against the flange 3, is maintained, thereby preventing occurrence of falling-off of the product and/or defects due to water leakage. Further, poor surface appearance of the weather strip does not occur either.

Furthermore, since the fitting base 11 is formed of the dense rubber material with porosity, usage of a rubber material can be reduced, thereby reducing a fabrication cost.

Further, since the thermal expansion microcapsules are pre-prepared into the master batch to be subsequently mixed by the open mills (mixing rolls), it is possible to accurately disperse by the adequate amount thereof, and to enhance workability. As a result, the air bubbles can be evenly formed throughout the fitting base 11 with ease. If at the adequate temperature (the temperature at which the thermal expansion microcapsules undergo no expansion), the mixing of the thermal expansion microcapsules in powdery state is possible even in the closed mixing machine (the kneader, Banburry mixer, and so forth), thereby obtaining the same advantageous effects described as above.

Still further, since the metal core member 13 is embedded in the fitting base 11, it is possible to further enhance the holding strength of the fitting base 11, against the flange 3. Then, since the thermal expansion microcapsules do not cause the gas to be evolved unlike the chemical blowing agent, the blisters hardly occur at the interface between the metal core member 13 and the fitting base 11 like with the case of a normal dense rubber. Accordingly, the sufficient holding strength of the fitting base 11, against the flange 3, is maintained, thereby preventing occurrence of the falling-off of the product and the defects due to water leakage.

Yet further, with the weather strip 10 according to the invention, even if vulcanization is applied thereto by the fluidized-bed vulcanization process (HFB vulcanization) prone to occurrence of the blisters, it is possible to prevent occurrence of the blisters. Accordingly, by applying UHF vulcanization insusceptible to occurrence of the blisters, it is possible to prevent occurrence of the blisters with greater reliability.

Furthermore, it is to be pointed out that the weather strip 10 according to the invention is not limited to one fitted to the flange 3 formed along the door opening 2 of the automobile body 1, and the invention is applicable to various weather strips such as those fitted to the door panel 4, a roof, a trunk, and so forth. Further, the fitting base 11 is not limited to one resembling the letter U in section. Still further, the invention can be applied to a glass run channel as well.

### WORKING EXAMPLES

The inventors took measurements on specific gravity and strength as to the fitting base 11 of the weather strip 10 according to the embodiment of the invention, and the fitting base 11 formed of the dense rubber material with porosity made by use of the chemical blowing agent. Table 1 shows results of the measurements.

TABLE 1

| | Working | Working | Conventional | Conventional | Conventional | TSM |
|---|---|---|---|---|---|---|
| | example. 1 | example 2 | example 1 | example 2 | example 3 | specification. |
| Specific | 0.91 | 1.03 | 1.08 | 1.12 | 1.07 | — |
| gravity | | | | | | |
| Spring | 67 | 69 | 62 | 63 | 62 | 70 ± 5 |
| hardness | | | | | | |
| HS (JISA) | | | | | | |
| tensile | 6.3 | 8.2 | 6.5 | 7.5 | — | 7.8 or |
| strength | | | | | | higher |
| HB | | | | | | |
| (Mpa) | | | | | | |

As is evident from the results of the measurements, the fitting base 11 of the weather strip 10, according to each of working examples 1 and 2 of the invention, has specific gravity around 1.0, and is lighter in weight than those according to conventional examples 1 to 3, having specific gravity around 1.1. Further, as to strength, those according to conventional examples 1 to 3 do not meet the standard of TSM specification in respect of spring hardness, and in contrast, those according to working examples 1 and 2 are found meeting the standard. Furthermore, the fitting base 11 according to working example 2 is found sufficiently meeting the standard in respect of tensile strength. It is evident from the above that the weather strip 10 according to the invention is light in weight, and excellent in hardness and strength.

Further, the inventors fabricated the fitting base 11 of the weather strip 10 according to the invention and measured respective diameters of a multitude of air bubbles formed therein to thereby find average values thereof. At the same time, they measured respective diameters of a multitude of air bubbles formed in a fitting base 11 foamed by a conventional technology using the chemical blowing agent to thereby find average values thereof. Surface roughness (arithmetic mean value Ra) of rubber after vulcanization was concurrently measured by use of an ultra-depth shape measuring microscope (VK—8510 manufactured by Keyence Co. Ltd.). Table 2 shows results of the measurements.

TABLE 2

| | | | (for reference) | |
|---|---|---|---|---|
| | | | | Comparative |
| | | | | example |
| | | | | (high temperature |
| | Working | Conventional | Dense | expansion |
| | example 1 | example 1 | rubber | type) |
| Average air | 78.0 | 590.0 | — | 282.0 |
| bubble | | | | |
| diameter | | | | |
| (μm) | | | | |
| Surface | 17.0 | 14.5 | 9.5 | 62.9 |
| roughness | | | | |
| (μm) | | | | |

As shown in Table 2, an average diameter (78.0 μm) of air bubbles according to Working Example 1 of the invention is found extremely small in comparison with that (590.0 μm) according to Conventional Example 1. It is evident from this that Working Examples according to the invention can meet the standard in respect of tensile strength even if the specific gravity is below 1.10. Further, surface roughness (Ra: 17.0 μm) of rubber according to Working Example 1 of the invention is substantially equivalent to that (Ra: 14.5 μm) according to Conventional Example 1, and the fitting base 11 of the weather strip 10 according to the invention has a surface on which visible roughness are not formed, so that the surface thereof is found excellent in outer appearance (for reference, Working Example of the thermal expansion microcapsules of the high-temperature expansion type is also shown in Table 2).

What is claimed is:

1. An automobile weather strip comprising a fitting base and a bulb shape, wherein the fitting base is formed of a dense rubber material with porosity containing air bubbles not more than 100 μm in average diameter, obtained by mixing a predetermined amount of thermal expansion microcapsules each having particles 3 to 20 μm (preferably, 5 to 15 μm) in average diameter, an expansion start temperature in a range of 110 to 150° C., a maximum expansion temperature in a range of 130 to 150° C., and a shell-wall made of acrylonitride copolymer to be subsequently foamed in a vulcanization process.

2. A method for fabricating an automobile weather strip comprising a fitting base and a bulb shape, said method including the step of forming the fitting base, comprising the steps of preparing a predetermined amount of thermal expansion microcapsules each having particles 3 to 20 μm (preferably, 5 to 15 μm) in average diameter, an expansion start temperature in a range of 110 to 150° C., a maximum expansion temperature in a range of 130 to 150° C., and a shell-wall made of acrylonitride copolymer, mixing the predetermined amount of the thermal expansion microcapsules to be subsequently foamed in a vulcanization process, wherein the shell-walls are caused to expand with rubber still in soft state before the rubber is vulcanized and the shell-walls having a low melting point (not higher than about 150° C.) are in use, thereby causing the shell-walls to be melt in a rubber vulcanizing furnace, and forming a dense rubber material with porosity with a smoothed surface, containing air bubbles not more than 100 μm in average diameter, using the thermal expansion microcapsules small in average particle diameter, and expansion multiplying factor.
